(19) United States
(12) Patent Application Publication
(10) Pub. No.: US 2025/0286781 A1
(43) Pub. Date: Sep. 11, 2025

(54) METHOD AND APPARATUS FOR DATA TRANSMISSION IN SERVICE-BASED ARCHITECTURE IN WIRELESS COMMUNICATION SYSTEMS

(71) Applicant: SAMSUNG ELECTRONICS CO., LTD., Suwon-si, Gyeonggi-do (KR)

(72) Inventors: Neha SHARMA, Bangalore, Karnataka (IN); Anshuman NIGAM, Bangalore, Karnataka (IN)

(21) Appl. No.: 18/868,629

(22) PCT Filed: May 24, 2023
(86) PCT No.: PCT/KR2023/007042

§ 371 Date: Nov. 22, 2024

(30) Foreign Application Priority Data
May 25, 2022 (IN) 202241030075
May 11, 2023 (IN) 202241030075

(51) Int. Cl. H04L 41/0895; H04L 41/084; H04W 12/106

(52) U.S. Cl. CPC H04L 41/0895; H04L 41/084; H04W 12/106

(57) ABSTRACT

The disclosure relates to a 5G or 6G communication system for supporting a higher data Embodiments of the disclosure describe a method for data transmission in a service-based architecture by a network hub (100). The method includes receiving a message from a plurality of network function (NF) nodes (300A-300N). The method further includes sending the received message to a user equipment (UE) (200), wherein the received message is processed by the UE (200). The method includes receiving a response message from the UE (200) in response to processing the received message. The method includes identifying NF node information in the received response message. The method includes determining, based on the identified NF node information, whether the received response message is transmitted to a single NF node or multiple NF nodes of the plurality of NF nodes (300A-300N). The method includes transmitting of the received response message to the single NF node or the multiple NF nodes based on indication of the identified NF node information.

### TECHNICAL FIELD

The present invention generally relates to wireless communication, and more specifically relates to a method and a system for data transmission in a service-based architecture.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Technical Problem

The present invention has been made to address at least the above problems and/or disadvantages and to provide at least the advantages described below. Accordingly, an aspect of the present invention provides a method and apparatus for performing data transmission in service-based architecture.

### Solution to Problem

The summary is provided to introduce a selection of concepts, in a simplified format, which is further described in the detailed description of the invention. This summary is neither intended to identify key or essential inventive concepts of the invention nor is it intended for determining the scope of the invention.

According to one embodiment of the present disclosure, a method for data transmission in a service-based architecture. The method includes receiving, by a network hub, a message from a plurality of network function (NF) nodes. The method further includes sending, by the network hub, the received message to a user equipment (UE), wherein the received message is processed by the UE. The method further includes receiving, by the network hub, a response message from the UE in response to processing the received message. The method further includes identifying, by the network hub, NF node information in the received response message. The method further includes determining, based on the identified NF node information, by the network hub, whether the received response message is transmitted to a single NF node of the plurality of NF nodes or multiple NF nodes of the plurality of NF nodes. The method further includes performing, by the network hub, one of, transmission of the received response message to the single NF node when the identified NF node information indicates that the received response message is associated with the single NF node, or transmission of the received response message to the multiple NF nodes when the identified NF node information indicates that the received response message is associated with the multiple NF nodes.

According to another embodiment of the present disclosure, the network hub for data transmission in the service-based architecture. The network hub includes a system, wherein the system includes a memory, a processor, and a data transmission controller coupled with the processor and the memory. The data transmission controller receives the message from the plurality of NF nodes. The data transmission controller further sends the received message to the UE, wherein the received message is processed by the UE. The data transmission controller further receives the response message from the UE in response to processing the received message. The data transmission controller identifies the NF node information in the received response message. The data transmission controller further determines, based on the identified NF node information whether the received response message is transmitted to the single NF node of the plurality of NF nodes or multiple NF nodes of the plurality of NF nodes. The data transmission controller further performs, one of, transmission of the received response message to the single NF node when the identified NF node information indicates that the received response message is associated with the single NF node, or transmission of the received response message to the multiple NF nodes when the identified NF node information indicates that the received response message is associated with the multiple NF nodes.

According to another embodiment of the present disclosure, the UE for data transmission in the service-based architecture. The UE includes a system, wherein the system includes a memory, a processor, and a data transmission controller coupled with the processor and the memory. The data transmission controller receives the message from the network hub. The data transmission controller further detects, upon the received message, at least one of a network indication, an action on layers or modules, and preconfigured information. The data transmission controller further adds, based on at least one of the detected network indication, the detected action on layers or modules, and the detected preconfigured information, a single NF header or multiple headers in the response message. The data transmission controller further sends the response message to the network hub.

To further clarify the advantages and features of the present invention, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail in the accompanying drawings.

### Advantageous Effects of Invention

Advantages, and salient features of the invention will become apparent to those skilled in the art from the following detailed description, which, taken in conjunction with the annexed drawings, discloses exemplary embodiments of the invention. For more enhanced communication system, there is a need for method and network for data transmission in service-based architecture.

### BRIEF DESCRIPTION OF DRAWINGS

These and other features, aspects, and advantages of the present invention will become better understood when the following detailed description is read with reference to the accompanying drawings in which like characters represent like parts throughout the drawings, wherein:

FIG. 1A illustrates a 5G service-based core network architecture with one or more interfaces within the CP, according to the prior art;

FIG. 1B illustrates a problem associated with the 5G service-based core network architecture, according to the prior art;

FIG. 2 is a sequence diagram illustrating a problem scenario(s) of serial transmission associated with an existing data transmission mechanism in a 6G service-based architecture, according to the prior art;

FIG. 3A illustrates a network architecture of a sixth-generation (6G) wireless communication system for data transmission in a service-based architecture, according to an embodiment as disclosed herein;

FIG. 3B illustrates a network architecture of a sixth-generation (6G) wireless communication system for data transmission in a service-based architecture, according to an embodiment as disclosed herein;

FIG. 4 is a sequence diagram illustrating a method for data transmission in the service-based architecture, according to an embodiment as disclosed herein;

FIG. 5 is a flow diagram illustrating a method for the data transmission in the service-based architecture, according to an embodiment as disclosed herein;

FIG. 6 is a flow diagram illustrating a method for identifying one or more Network Function (NF) nodes at a network hub for the data transmission in the service-based architecture, according to an embodiment as disclosed herein;

FIG. 7 illustrates one or more header structures for a control packet during the data transmission in the service-based architecture, according to an embodiment as disclosed herein;

FIG. 8 illustrates one or more structuring configurations of the NF header field for the data transmission in the service-based architecture, according to an embodiment as disclosed herein;

FIG. 9 is a flow diagram illustrating a method for identifying a single NF node or multiple NF nodes from the one or more NF nodes at the network hub for the data transmission in the service-based architecture, according to an embodiment as disclosed herein;

FIG. 10 is a flow diagram illustrating a method for adding information associated with the single NF node or multiple NF nodes from the one or more NF nodes at the UE for the data transmission in the service-based architecture, according to an embodiment as disclosed herein;

FIG. 11 illustrates a block diagram of the network hub for the data transmission in the service-based architecture, according to an embodiment as disclosed herein;

FIG. 12 illustrates a block diagram of the UE for the data transmission in the service-based architecture, according to an embodiment as disclosed herein; and

FIG. 13A illustrates an impact on the existing header structure in case a new NF header structure is added in one or more messages for the data transmission in the service-based architecture, according to an embodiment as disclosed herein.

FIG. 13B illustrates an impact on the existing header structure in case a new NF header structure is added in one or more messages for the data transmission in the service-based architecture, according to an embodiment as disclosed herein.

Further, skilled artisans will appreciate those elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks that carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the proposed method. Likewise, the blocks of the embodiments may be physically combined into more complex blocks without departing from the scope of the proposed method.

The accompanying drawings are used to help easily understand various technical features and it should be understood that the embodiments presented herein are not limited by the accompanying drawings. As such, the proposed method should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Many broadband wireless technologies have been developed in recent years to satisfy a growing number of broadband customers and provide improved applications and services. A second-generation (2G) wireless communication system has been developed to provide a voice service(s) while ensuring mobility of a user(s). A third-generation (3G) wireless communication system supports not only voice service(s) but also data service(s). In recent years, a fourth-generation (4G) wireless communication system has been developed to provide high-speed data service(s). However, the 4G wireless communication system suffers from a lack of resources to meet the growing demand for the high-speed data service(s). This problem is solved by a deployment of a fifth-generation (5G) wireless communication system to meet an ever-growing demand for the high-speed data service(s). Furthermore, the 5G wireless communication system provides ultra-reliability and supports a low latency application(s).

According to 3GPP TS 23.501, a basic architecture of the 5G wireless communication system is service-based (Service-Based Architecture (SBA)), and interactions between Network Function(s) (NFs) are represented in two ways, which are mentioned below.
a. A service-based representation, where the NFs (e. g. Access & Mobility Management Function (AMF)) within a Control Plane (CP) enable other authorized NFs to access their services. The service-based representation also includes a point-to-point reference point where necessary.
b. A reference point representation, where an interaction exists between the NF services in the NFs described by a point-to-point reference point (e. g. N11) between any two network functions (e. g. AMF and Session Management Function (SMF)).

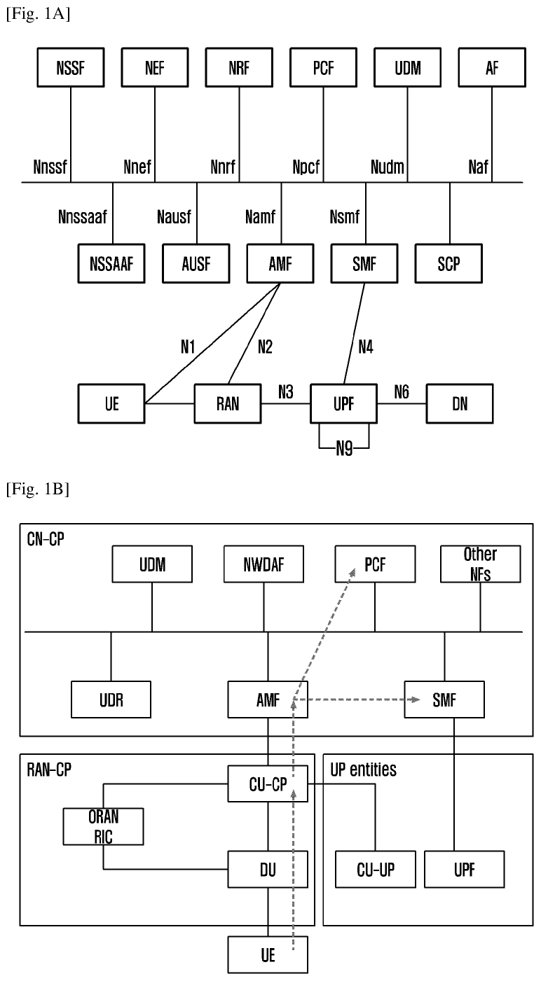

FIG. 1A illustrates a 5G service-based core network architecture with one or more interfaces within the CP, according to the prior art. The 5G service-based core network architecture brings more scalability and flexibility as any NF node can interact with any other node. The 5G wireless communication system architecture may leverage service-based interactions between CP NFs. In this case, a set of NFs providing services to other authorized NFs to access their services through a Service-Based Interface (SBI). An NF service is one type of capability exposed by the NF node (e.g., NF service producer) to another authorized NF (e.g., NF service consumer) through the SBI. The NF service may support one or more NF service operation(s). The NFs may offer different functionalities and thus different NF services. Each of the NF services offered by the NF may be self-contained, acted upon, and managed independently from other NF services offered by the same NF (e. g. for scaling, and healing).

The SBI describes how a given NF provides or exposes a set of services. The SBI interface via which the NF service functions are invoked. A Namf interface, an Nsmf interface, a Nudm interface, an Nnrf interface, an Nnssf interface, a Nausf interface, a Nnef interface, an Nsmsf interface, a Nudr interface, an Npcf interface, an N5g-Equipment Identity Register (EIR) interface, and an Nlmf interface are all service-based interfaces defined in 3GPP TS 23.501, as illustrated in FIG. 1A. The 5G service-based core network architecture consists of one or more NFs, for example, an Authentication Server Function (AUSF), an Access and Mobility Management Function (AMF), a Data Network (DN) (e.g., operator services, Internet access or 3rd party services), an Unstructured Data Storage Function (UDSF), a Network Exposure Function (NEF), a Network Repository Function (NRF), a Network Slice Specific Authentication and Authorization Function (NSSAAF), a Network Slice Selection Function (NSSF), a Policy Control Function (PCF), a Session Management Function (SMF), a Unified Data Management (UDM), a Unified Data Repository (UDR), a User Plane Function (UPF), a UE radio Capability Management Function (UCMF), an Application Function (AF), a User Equipment (UE), a (Radio) Access Network ((R)AN), a 5G-Equipment Identity Register (5G-EIR), a Network Data Analytics Function (NWDAF), and a Charging Function (CHF).

FIG. 1B illustrates a problem associated with the 5G service-based core network architecture, according to the prior art. The 5G core is based on the SBI but a Radio Access Network (RAN) to a Core Network (CN) is still a point-to-point interaction. Due to NF virtualization, the RAN, as well as the CN, may be at the same location but still, the RAN can only interact with a single CN entity (i.e., AMF). The RAN as well as the AMF becomes an anchor for all UE control messages (as shown by a dotted arrow(s)/path(s)) and each message has to pass through the single CN entity or network entities which is inefficient as it impacts the overall latency of the CP. This leads to increased hops, delay, and computational overhead for the delivery of the control messages. So, the 5G service-based CN architecture has several disadvantages and/or limitations which are mentioned below.
a. Due to the point-to-point interaction/communication, a number of hops increases, and eventually a control plane latency also increases., This leads to an increase in overhead at network nodes and control procedure completion time due to the involvement of multiple network nodes (e.g., NF node).
b. Due to the point-to-point interaction/communication, redundant functionalities in the RAN and the CP of the CN increases. There is a need to use complex protocols like NG Application Protocol (NGAP) to communicate between two network nodes.

As a result, there is a need to create a more flexible and simple network function for a sixth-generation (6G) wireless communication system that can give a degree of freedom for NF placement owing to cloudification and virtualization of NFs.

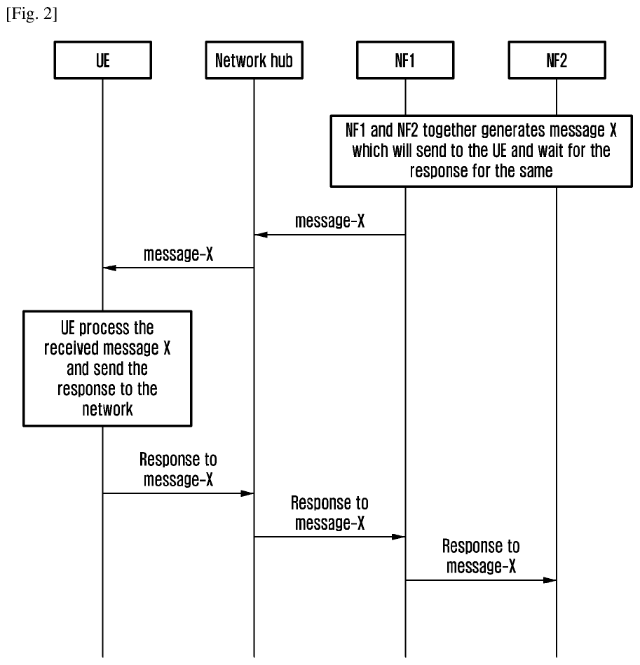

FIG. 2 is a sequence diagram illustrating a problem scenario(s) of serial transmission associated with an existing data transmission mechanism in a 6G service-based architecture, according to the prior art. Consider a scenario where an NF-1 node and an NF-2 node together generate a message-X for a User Equipment (UE) and send it to the UE via a network hub by utilizing different functionality that exists at the NF-1 node and the NF-2 node. Once the UE receives the message-X, the UE processes the received message-X, and the UE then sends a response for the received message-X to the network hub. The network hub then sends the response to the NF-1 node directly (step-1) and sends the response to the NF-2 node via the NF-1 node (step-2). Although the network hub has direct access to the NF-2 node, the network hub delivers the response to the NF-2 node via the NF-1 node due to the existing data transmission mechanism in the service-based architecture. As a result, the existing data transmission mechanism may not assist in achieving the benefits of the SBI since the existing data transmission mechanism does not facilitate the simultaneous transmission of messages to multiple nodes (e.g., NF nodes). In addition, the existing data transfer mechanism's control plane latency and the number of hopes rise. So, there is a requirement to design a new mechanism that can handle such scenarios.

Thus, it is desired to address the above-mentioned disadvantages or other shortcomings or at least provide a useful alternative for the data transmission mechanism in the service-based architecture.

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in one embodiment”, “in another embodiment”, and similar language throughout this specification may, but do not necessarily, all refer to the same embodiment.

The terms “comprise”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks that carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the invention. Likewise, the blocks of the embodiments may be physically combined into more complex blocks without departing from the scope of the invention.

The accompanying drawings are used to help easily understand various technical features and it should be understood that the embodiments presented herein are not limited by the accompanying drawings. As such, the present disclosure should be construed to extend to any alterations, equivalents, and substitutes in addition to those which are particularly set out in the accompanying drawings. These terms are generally only used to distinguish one element from another.

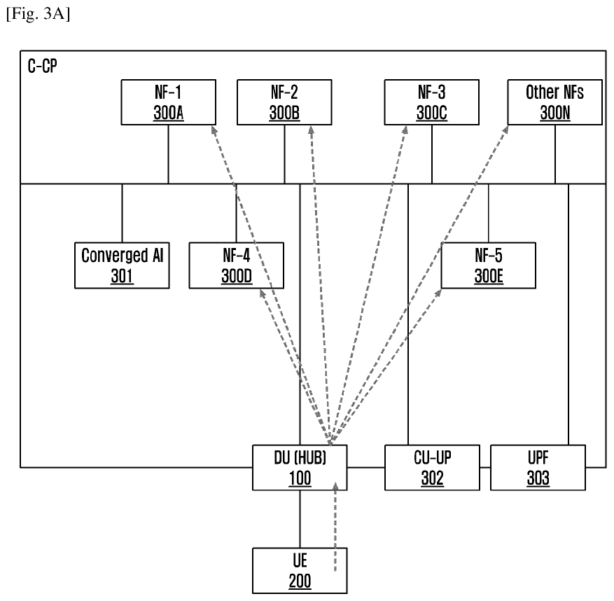

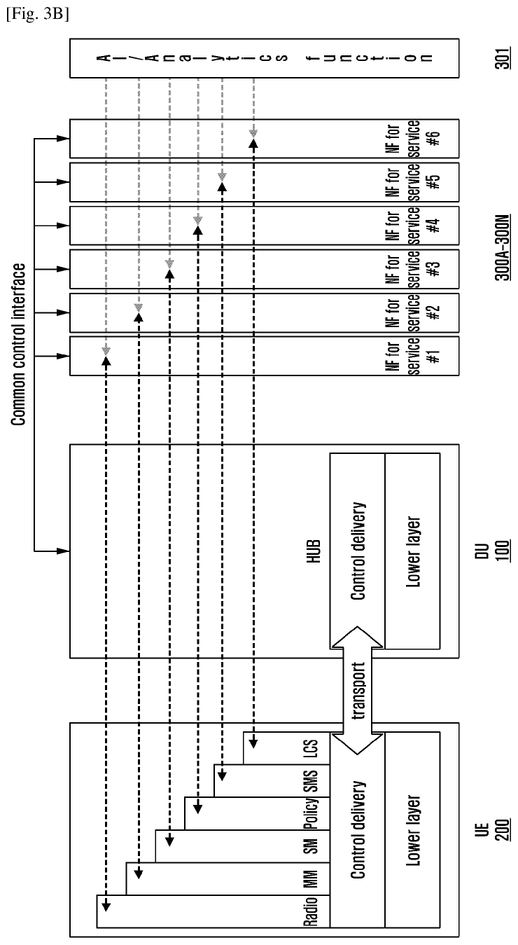

FIGS. 3A-3B illustrates a network architecture of a sixth-generation (6G) wireless communication system for data transmission in a service-based architecture, according to an embodiment as disclosed herein.

Referring to FIG. 3A: In one or more embodiments, the network architecture includes a network hub (100) (e.g., Distributed Unit (DU)), a User Equipment (UE) (200), one or more Network Function (NF) nodes (300A to 300N), a converged Artificial Intelligence (AI) (301), which is handling all AI-related data, a Centralized Unit User Plane CU-UP (302), and a User Plan Function (UPF) (303).

In one or more embodiments, in the network architecture, a Radio Access Network (RAN) is also acting as a service-based RAN as a result the RAN can interact with any NF node (300A to 300N). All the NF nodes (300A to 300N) may be controlled by a module hub (i.e., network hub (100)) or a switch or a CMD which is a single anchor point for all UE messages. The network hub (100) may be an independent module, or located at a specific NF node (e.g., 300A to 300N) or located along with the DU or may be kept at various NF nodes (e.g., 300A to 300N). All control message transmissions between the UE (200) and the network hub (100) are managed through a single layer. The UE's control message is parsed at the network hub (100) and then the message is delivered directly to its destination node (e.g., NF node).

In one or more embodiments, there is an SBI interface between the network hub (100) and a rest of the NF nodes (e.g., 300A to 300N) and SBI connectivity may use a Hypertext Transfer Protocol (HTTP) two types (HTTP/2) or equivalent protocols.

In one or more embodiments, multiple NF nodes (e.g., 300A to 300N) may belong to different services like connection management, session management, handovers, service request, etc. The network hub (100) can directly interact with any NF which can decrease overall network latency.

In one or more embodiments, one of the possible implementations for the NF nodes (e.g., 300A to 300N) could be that where the RAN and an Access and Mobility Management Function (AMF) node are combined and a new module/NF node is created, for example, the NF-1 node (300A) or a Control Management Function (CMF). The new module CMF handles all RRC as well as exiting NAS-related functionality. The CMF handles connection establishment, registration procedure, handover, handling of radio link control and medium access control, and other basic NAS functionalities (e.g., Enhanced Session Management Function (eSMF), which handles all session management and bearer-related functionalities), similarly other NF node (300A to 300N) handles specific services related to a various procedure. The network hub (100) can directly interact with any NF node (300A to 300N) which can decrease the overall network latency. Creation of the new module/NF node and functional re-composition or creation of new service-based modules may directly impact design aspects like a design of signaling radio bearer and associated transmit and receive operation and placement of various modules like a Packet Data Convergence Protocol (PDCP), a Service Data Adaptation Protocol (SDAP), a Radio link control (RLC), a Medium Access Control (MAC), a Physical (PHY), etc.

In one or more embodiments, the network architecture may be an end-to-end to service-based architecture, and to make it more efficient, flexible, and simple, there is a need to split network function between the RAN and a Core Network (CN) for the 6G wireless communication system which can provide a degree of freedom for NF placement due to cloudification and virtualization of the NFs (e.g., 300A to 300N).

In one or more embodiments, the NFs (e.g., 300A to 300N) may handle different procedures but for a few procedures, there may be a dependency on multiple NFs (e.g., 300A to 300N) for example one module or NF node may handle a bearer functionality and the other module or NF node may handle a signaling radio bearer functionality. During a handover procedure, there is a need to have interaction between both the NF nodes. Thus, there is a need to define a transmit and receive operation for such procedures which ensures that there is minimal CP latency with minimal hops.

Referring to FIG. 3B: In one or more embodiments, the network architecture includes the network hub (100) (e.g., Distributed Unit (DU)), the UE (200), one or more NF nodes (300A to 300N), the converged Artificial Intelligence (AI) (301) which is handling all AI related data. The DU is consist of HUB module which may take care of delivery of control messages to any of NF node (e.g., 300A to 300N). The HUB may require an identifier which may be used to identify the one or more NF nodes (e.g., 300A to 300N).

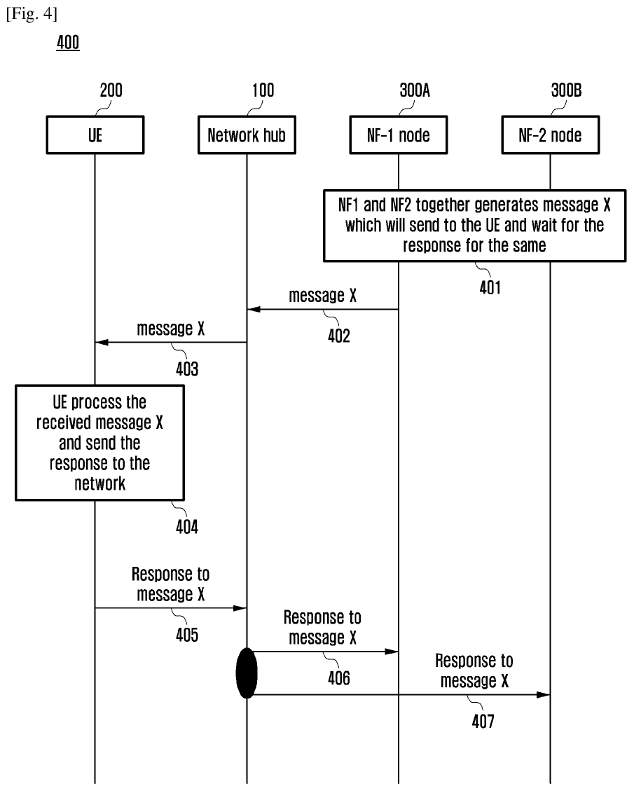

FIG. 4 is a sequence diagram illustrating a method (400) for data transmission in the service-based architecture, according to an embodiment as disclosed herein.

At step 401, the method (400) includes generating, by the NF-1 node (300A) and the NF-2 node (300B), a message (e.g., message-X) simultaneously for the UE (200) to indicate different functionality exists at different NFs (300A and 300B).

At steps 402-403, the method (400) includes sending, by the NF-1 node (300A) and the NF-2 node (300B), the generated message (e.g., message-X) to the UE (200) via the network hub (100).

At step 404, the method (400) includes receiving, by the UE (200), the generated message (e.g., message-X) from the network hub (100). The UE (200) then processes the received message (e.g., message-X), for example, the UE (200) prepares a response message for the received message (e.g., message-X) based on at least one of a network indication, an action on a layer(s) or module(s), and pre-configured information. The response message comprises NF node information.

At step 405, the method (400) includes sending, by the UE (200), the response message to the network hub (100).

At steps 406-407, the method (400) includes identifying, by the network hub (100), the NF node information in the received response message. The NF node information is identified based on at least one of the preconfigured information, header structure information of a control plane data packet, and header format information of an NF header field. The network hub (100) then determines, based on the identified NF node information, whether the received response message is transmitted to a single NF node of a plurality of NF nodes (e.g., 300A and 300B) or multiple NF nodes of the plurality of NF nodes (e.g., 300A and 300B). In the illustrated scenario, the network hub (100) transmits the received response message to the multiple NF nodes (e.g., 300A and 300B) simultaneously when the identified NF node information indicates that the received response message is associated with the multiple NF nodes (e.g., 300A and 300B).

As a result, Control Plane (CP) latency decreases and the number of hops for data transfer decreases. The method (400) aids in achieving the benefits of a Service-Based Interface (SBI) and a new architecture for a 6G wireless communication system in which the network hub (100) may connect with any NF node (e.g., 300A and 300B) and contributes to lowering latency and hop count(s). The method (400) provides a parallel transmission of the message to various NF nodes (e.g., 300A and 300B).

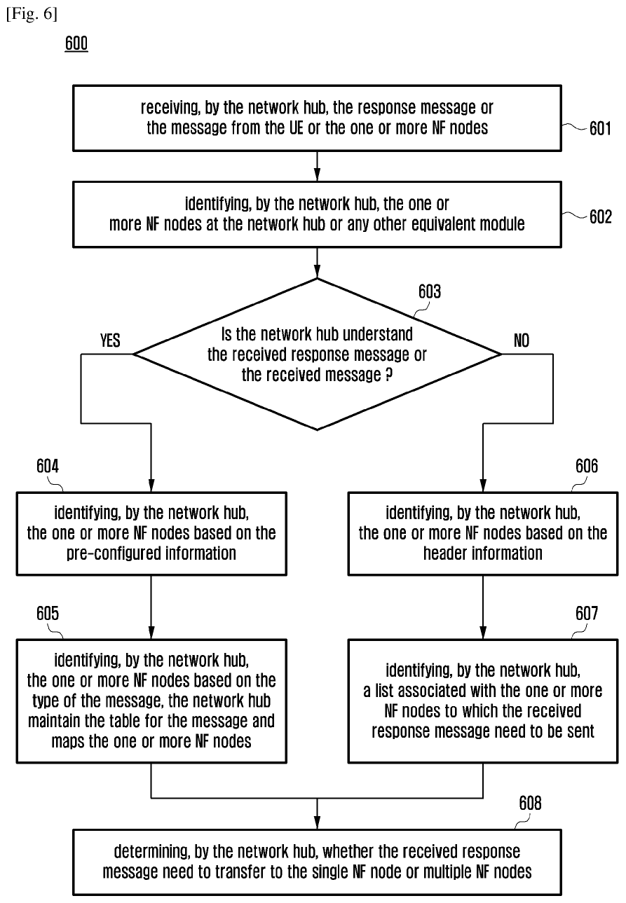

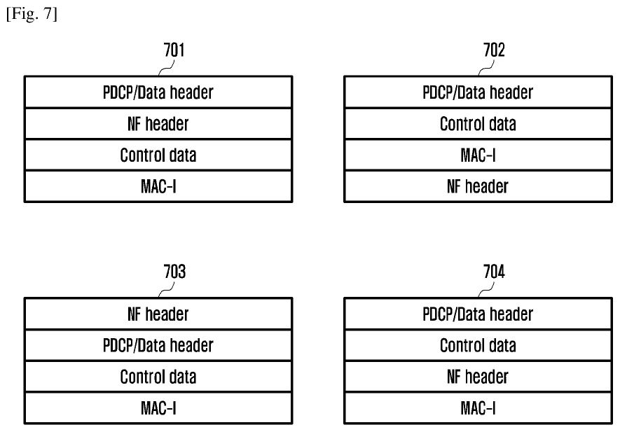

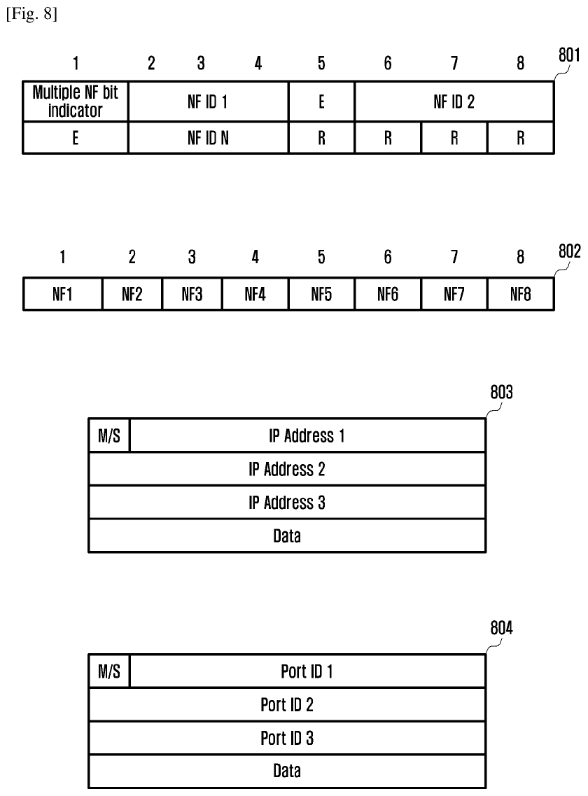

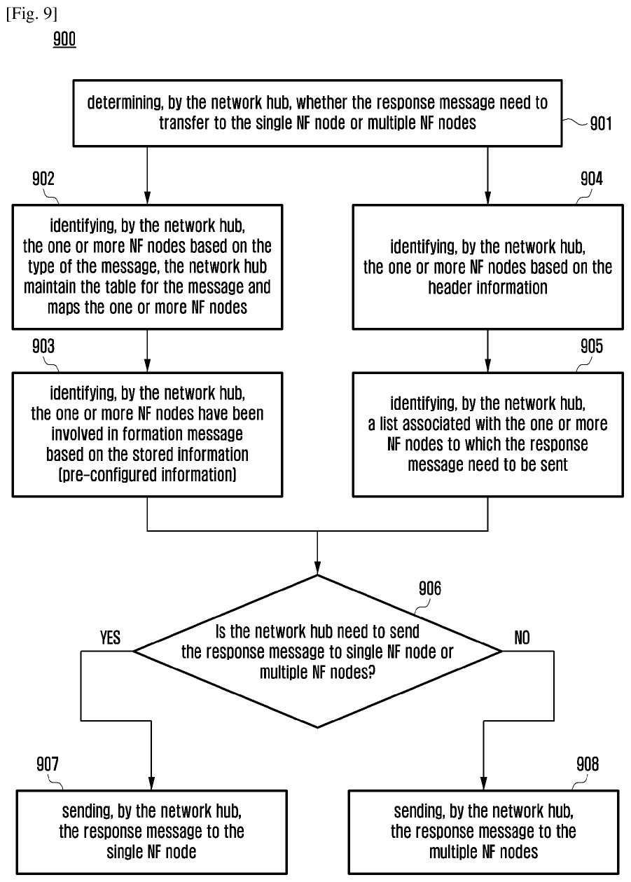

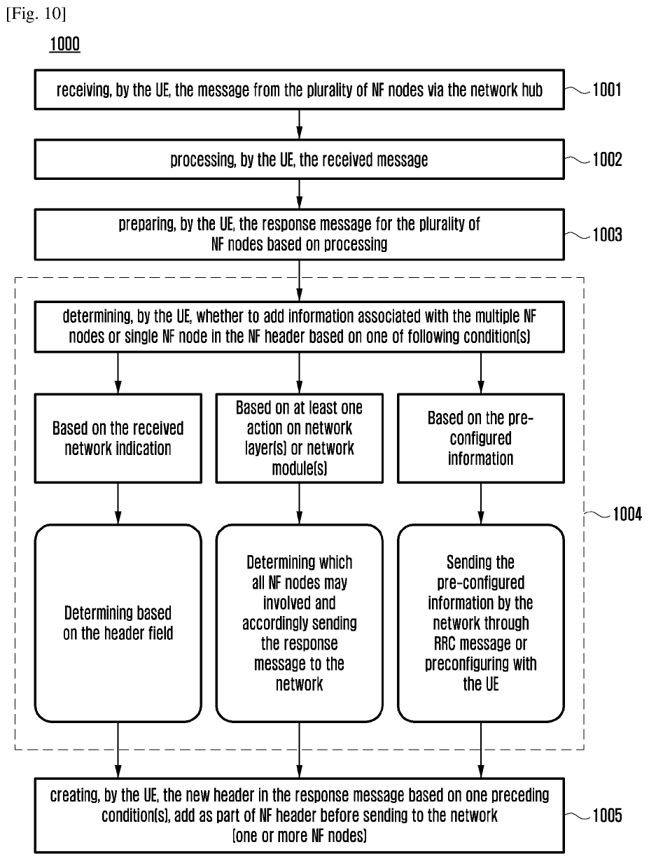

In one or more embodiments, the method (400) establishes one or more configurations for the network hub (100) and the UE (200) to execute the parallel transmission, which is detailed below.
a. The network hub (100) identifies the one or more NF nodes (e.g., 300A and 300B) based on at least one of the preconfigured information from a network, a new header structure, and a new header format for an NF header, as described in conjunction with FIG. 6, FIG. 7, and FIG. 8.
b. The network hub (100) determines whether the response message transmits to the single NF node of the plurality of NF nodes (e.g., 300A and 300B) or multiple NF nodes of the plurality of NF nodes (e.g., 300A and 300B), as described in conjunction with FIG. 9.
c. The UE (200) determines to add the NF node information in the NF header while sending the response message to the network hub (100), as described in conjunction with FIG. 10.

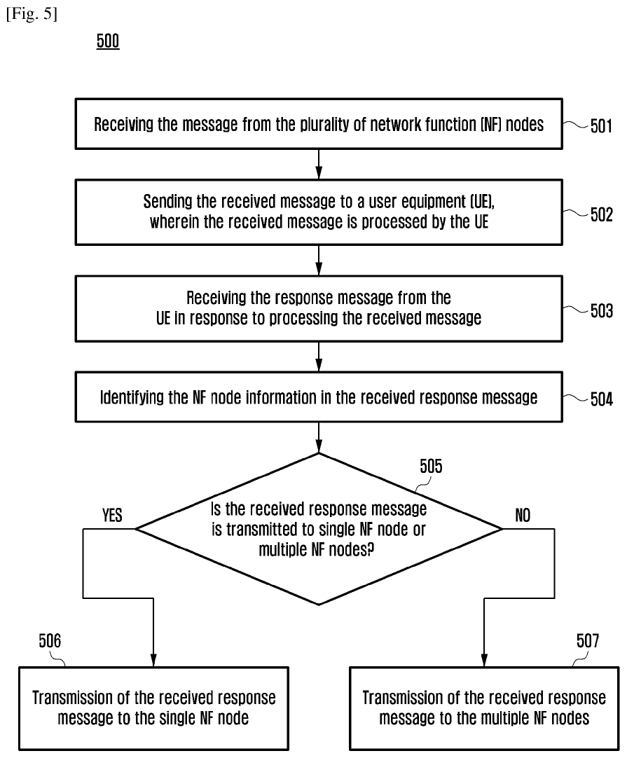

FIG. 5 is a flow diagram illustrating a method (500) for the data transmission in the service-based architecture, according to an embodiment as disclosed herein.

At step 501, the method (500) includes receiving the message from the plurality of network function (NF) nodes (300A-300N), which relates to step 402.

At step 502, the method (500) includes sending the received message to the UE (200), wherein the received message is processed by the UE (200), which relates to steps 403 and 404. In one embodiment, the UE (200) detects at least one of a network indication, an action on network layers or network modules, and preconfigured information. The UE (200) then adds, based on at least one of the detected network indication, the detected action on layers or modules, and the detected preconfigured information, a single NF header or multiple headers in the response message. The UE (200) then sends the response message to the network hub (100).

In one embodiment, the UE (200) or at least one network device adds the NF header field in any of the existing network layers (e.g., PDCP, RLC, MAC, etc.), or a new network layer based on the preconfigured information shared by the at least one network device. In one embodiment, the at least one network device may include, for example, the plurality of NF nodes (300A-300N) (e.g., UDM, AMF, SMF, etc.), the network hub (100), and any other network entity (e.g., CU-UP, UPF, etc.).

At step 503, the method (500) includes receiving the response message from the UE (200) in response to processing the received message, which relates to step 405.

At step 504, the method (500) includes identifying the NF node information in the received response message, which relates to steps 405, 406, and 407. The NF node information is identified based on at least one of the preconfigured information, the header structure information of the control plane data packet, and the header format information of the NF header field. The preconfigured information comprises a type of message, an indication of a single NF node or multiple NF nodes, and a type of NF node.

In one embodiment, the network hub (100) receives the preconfigured information from the at least one network device. The network hub (100) then stores the preconfigured information in a tabular format. The network hub (100) then dynamically updates the preconfigured information based on a number of NF nodes of the plurality of NF nodes (300A-300N) involved during the data transmission.

In one embodiment, the header structure information of the control plane data packet comprises one or more configurations for adding the NF header field to any existing network layer or new network layer, which are explained below, as described in conjunction with FIG. 7.
a. The UE (200) or the at least one network device adds the NF header field after processing of layer-2 of the existing network layer, after a layer-2 header, and before a control plane data packet, wherein the layer-2 comprises a packet data convergence protocol (PDCP) layer, a radio link control (RLC) layer, and a medium access control (MAC) layer.
b. The UE (200) or the at least one network device adds the NF header field after processing of layer-2 of the existing network layer and at end of each control plane data packet.
c. The UE (200) or the at least one network device adds the NF header field at beginning of each control plane data packet.
d. The UE (200) or the at least one network device adds the NF header field before a message authentication code-integrity (MAC-I) packet.

In one embodiment, the header format information for the NF header field comprises one or more structuring configurations of the NF header field, which are explained below, as described in conjunction with FIG. 8.
a. One-bit length for a multiple NF bit indication, three-bit length for an NF identity (NF-ID) of a specific NF node of the plurality of NF nodes (300A-300N), one-bit length for an extension bit, and one or more one-bit lengths of reserved bits.
b. One or more NF bits, wherein each bit corresponds to the specific NF node of the plurality of NF nodes (300A-300N).
c. One or more internet protocol (IP) addresses, wherein each IP address corresponds to the specific NF node of the plurality of NF nodes (300A-300N).
d. One or more port identities (IDs), wherein each port id corresponds to the specific NF node of the plurality of NF nodes (300A-300N).

In one embodiment, the header format information is preconfigured between the UE (200) and the at least one network device or shared by the at least one network device with the UE (200).

At step 505, the method (500) includes determining, based on the identified NF node information whether the received response message is transmitted to a single NF node of the plurality of NF nodes (300A-300N) or multiple NF nodes of the plurality of NF nodes (300A-300N), which relates to steps 406 and 407.

At step 506, the method (500) includes transmission of the received response message to the single NF node when the identified NF node information indicates that the received response message is associated with the single NF node, which relates to steps 406 and 407.

At step 507, the method (500) includes transmission of the received response message to the multiple NF nodes when the identified NF node information indicates that the received response message is associated with the multiple NF nodes, which relates to steps 406 and 407.

In one embodiment, the network hub (100) controls the plurality of NF nodes (300A-300N), wherein the network hub (100) operates as a single anchor point for all UE messages.

In one embodiment, the network hub (100) is located at a specific NF node of the plurality of NF nodes (300A-300N) or in conjunction with a Distributed Unit (DU) or one or more NF nodes of the plurality of NF nodes (300A-300N) or an independent device in the service-based architecture.

In one embodiment, one or more control message transmissions between the UE (200) and the network hub (100) are managed through a single layer.

In one embodiment, the network hub (100) uses a service-based interface (SBI) to communicate with the plurality of NF nodes (300A-300N), the plurality of NF nodes (300A-300N) controls one or more services, and the one or more services comprises a connection management, a session management, a handover, and a service request.

FIG. 6 is a flow diagram illustrating a method (600) for identifying one or more NF nodes (e.g., 300A and 300B) at the network hub (100) for the data transmission in the service-based architecture, according to an embodiment as disclosed herein.

At step 601, the method (600) includes receiving, by the network hub (100), the response message or the message from the UE (200) or the one or more NF nodes (e.g., 300A and 300B), which relates to step 402.

At step 602, the method (600) includes identifying, by the network hub (100), the one or more NF nodes (e.g., 300A and 300B) at the network hub (100) or any other equivalent module of the network device, upon receiving the response message or the message, which relates to steps 405, 406, and 407.

At step 603, the method (600) includes determining, by the network hub (100), whether the network hub (100) understands the received response message or the received message, which relates to steps 405, 406, and 407.

At step 604, the method (600) includes identifying, by the network hub (100), the one or more NF nodes (e.g., 300A and 300B) based on the pre-configured information in response to determining that the network hub (100) understands the received response message or the received message, which relates to steps 405, 406, and 407. In one embodiment, the pre-configured information is provided by the one or more NF nodes (e.g., 300A and 300B) to the network hub (100). In one embodiment, the network hub (100) may interact with any controller NW device which can store the pre-configured information. The pre-configured information may store in the tabular format, as shown in Table-1.

TABLE 1

| | Are multiple NF nodes | Type/list of |
|---|---|---|
| Type of message | handling the message? | the NF nodes |
| Message x | Yes | NF-1, NF-2 |
| Message y | No | NF-3 |
| Message z | No | NF-1 |

In one embodiment, any controller NW device may dynamically update the preconfigured information based on the number of NF nodes of the plurality of NF nodes (e.g., 300A and 300B) involved during the data transmission. Any controller NW device may share the dynamically updated preconfigured information with the network hub (100), and the network hub (100) accordingly may update the table and use the updated table to send the response message to the single NF node or multiple NF nodes (e.g., 300A and 300B).

At steps 605-608, the method (600) includes identifying, by the network hub (100), the one or more NF nodes (e.g., 300A and 300B) based on the type of the message, the network hub (100) may maintain the table and map the one or more NF nodes (e.g., 300A and 300B) for the received message/received response message, which relates to steps 405, 406, and 407. According to the embodiment, there is a field for each message that indicates whether the message is handled by the multiple NF nodes (e.g., 300A and 300B) or by the single NF node (e.g., 300A). If the message is handled by the multiple NF nodes (e.g., 300A and 300B), another column in the Table-1 is added to indicate the type of NF node. The Table-1 may be updated in response to a new message and if any other NF node is engaged in message generation. The network hub (100) determines whether the received response message needs to transfer to the single NF node (e.g., 300A) or the multiple NF nodes (e.g., 300A and 300B) based on identification.

At step 606, the method (600) includes identifying, by the network hub (100), the one or more NF nodes (e.g., 300A and 300B) based on the header information (e.g., header field) in response to determining that the network hub (100) does not understand the received response message or the received message, which relates to steps 405, 406, and 407. In one embodiment, the network hub (100) processes the data associated with the received message/received response message in response to determining that the network hub (100) does not understand the received response message or the received message.

At steps 607-608, the method (600) includes identifying, by the network hub (100), a list associated with the one or more NF nodes (e.g., 300A and 300B) to which the received response message needs to be sent, which relates to steps 405, 406, and 407. In one embodiment, the network hub (100) reads/analyzes the header information and determines whether the received response message needs to transfer to the single NF node (e.g., 300A) or the multiple NF nodes (e.g., 300A and 300B) based on identification.

FIG. 7 illustrates one or more header structures for the control packet during the data transmission in the service-based architecture, according to an embodiment as disclosed herein. The NF header is a new field that can be added to any existing or forthcoming network layer, such as layer-3, layer-2 or data layer, or layer-1. As shown in Table-2, for example, there are several alternatives for these NF header fields.

TABLE 2

| | One or more configurations for adding |
|---|---|
| | the NF header field to any existing |
| Alternatives/options | network layer or new network layer |
| Option-1 (701) | NF header field is added after layer-2 |
| | processing and after layer-2 header |
| Option-2 (702) | NF header field is added after layer-2 |
| | processing and added at the end of the packet |
| Option-3 (703) | NF header field is added at the beginning |
| | of the packet |
| Option-4 (704) | NF header field is added before the MAC-I packet |

In the option-1 (701), once a data plane process or PDCP process or RLC process or MAC process, or other processing has occurred, the UE (200) or NW may add the NF header. The UE (200) or NW may add the NF header before the control plane. If the PDCP or RLC adds the NF header field, the UE (200) may use a reserved bit for an SRB to indicate that a next field is the NF header field rather than a header field of any other layer. The same is applicable for an Unacknowledged Mode Data Protocol Data Unit (UMD PDU) and an Acknowledge Mode Data Protocol Data Unit (AMD PDU) at a Radio link control (RLC) layer. If it is done via the MAC layer, use the reserved bit to indicate the presence of the NF header field, the MAC may add the NF header field.

In the option-2 (702), at the end of each packet, the NF header field is added. Depending on the network configuration, the NF header field may or may not be ciphered and integrity protected. If the network device is configured, the NF header field is added after the MAC-I field as described in the existing system.

In the option-3 (703), at the beginning of each packet, the NF header field is added. The NF header field is added before the layer-2 processing or before the packet is sent to the data layer. The network layer(s) that handle the message add the NF header field. The network layer(s) can add the NF field based on the above-mentioned determining factor.

In the option-4 (704), once the data plane process or PDCP process or RLC process or MAC process, or other processing has occurred, the UE (200) or NW may add the NF header. The UE (200) or NW may add the NF header before the MAC-I field, if the PDCP or RLC adds the NF header field, the UE (200) may use the reserved bit for the SRB to mention that after data fields the next field is the NF header field instead of the MAC-I field. The same applies to the UMD PDU and the AMD PDU at the RLC layer. If it is done via the MAC layer, it uses the reserved bit to indicate the presence of the NF header field.

FIG. 8 illustrates the one or more structuring configurations of the NF header field for the data transmission in the service-based architecture, according to an embodiment as disclosed herein. As shown in Table-3, for example, there are several alternatives for structuring configurations of the NF header field.

TABLE 3

| | One or more structuring configurations |
|---|---|
| Alternatives/options | of the NF header field |
| Option-1 (801) | Control plane data packet carries NF ID |
| Option-2 (802) | Control plane data packet with multiple NF bits |
| Option-3 (803) | Control plane data packet with IP addresses |
| Option-4 (804) | Control plane data packet with Port IDs |

In the option-1 (801), the NF header field includes one or more fields such as the one-bit length for the multiple NF bit indicator, the three-bit length for an NF identity (NF-ID) of the specific NF node of the plurality of NF nodes, the one-bit length for the extension bit, and the one or more one-bit lengths of the reserved bits, as shown in Table-4.

TABLE 4

| Field | Information |
|---|---|
| Multiple NF | This field indicates whether a corresponding NF header |
| bit indicator | structure has multiple NF header fields or not, where |
| | value “0” indicates a single NF header and |
| | value “1” indicates multiple NF headers. |
| NF-ID | This field indicates a type of NF (e.g., “000” for |
| | NF-1, “001” for NF-2, etc.). This field indicates |
| | the type of NF information included in the |
| | corresponding control PDU. |
| Extension | This field indicates whether or not a set of NF IDs |
| bit (E) | follows. If the E field is set as “1” then it |
| | corresponds that another set of NF IDs exists, if |
| | the E field is set as “0” then it corresponds |
| | that no other NF ID is present in the header |
| | structure and the rest are reserved bit. |
| Reserved | Currently, this field is set as “0”, Reserved |
| bit | bits may be ignored by a receiver (e.g., NF node) |

In the option-2 (802), each NF bit corresponds to the specific NF node as preconfigured. Each NF bit may be mapped to a specific NF header. This can be standardized or can be preconfigured between the UE (200) and the network device. If any NF bit is set as 1 then it means that the message may be processed at that NF node (e.g., e.g., 300A), the network hub (100), or any other module finding that bit as NF as “1” may send the message to that NF node (e.g., 300A).

In the option-3 (803), in the SBI, each NF node (e.g., 300A) has the IP address and may connect with each other or any module through the IP address. Further, the network device shares the IP address for the particular NF node (e.g., 300A) with the UE (200) and based on above mentioned techniques when the UE (200) needs to add that particular NF node (e.g., 300A), the UE (200) may add the IP address associated with the particular NF node (e.g., 300A). Once the network hub (100) receives the packet, the network hub (100) receives information related to the IP address to which the network hub (100) has to send the packet. In this case, the network hub (100) does not determine the specific NF node (e.g., 300A), the network hub (100) can directly send the packet to multiple NF nodes (e.g., 300A and 300B) based on the IP address.

In the option-4 (804), in the new architecture, each NF node (e.g., 300A and 300B) may have been associated with a particular port ID which may be mapped to a specific IP address that may be used to communicate with each other or any module through the port ID. In this case, the network device shares the port ID for the particular NF node (e.g., 300A) with the UE (200) and based on above-mentioned techniques when the UE (200) needs to add that particular NF node (e.g., 300A), the UE (200) may add the port ID of the particular NF node (e.g., 300A). Once the network hub (100) receives the packet, the network hub (100) may learn about the port ID and corresponding IP address that the network hub (100) has stored/maintained, or the network hub (100) may learn that the port ID is associated with each NF node (e.g., 300A and 300B) to which the network hub (100) has to send the packet. In this case, the network hub (100) needs not to determine the particular NF node (e.g., 300A), the network hub (100) can directly send the packet to the multiple NF nodes (e.g., 300A and 300B) based on the port ID or based on mapping of the port ID to the IP address.

FIG. 9 is a flow diagram illustrating a method (900) for identifying the single NF node (e.g., 300A) or the multiple NF nodes (e.g., 300A and 300B) from the one or more NF nodes at the network hub for the data transmission in the service-based architecture, according to an embodiment as disclosed herein.

At step 901, the method (900) includes determining, by the network hub (100), whether the response message needs to transfer to the single NF node (e.g., 300A) or multiple NF nodes (e.g., 300A and 300B), which relates to steps 405, 406, and 407.

At step 902, the method (900) includes identifying, by the network hub (100), the one or more NF nodes (e.g., 300A and 300B) based on the type of the message, the network hub (100) maintains the table (e.g., Table-1) for the message and maps the one or more NF nodes (e.g., 300A and 300B), which relates to steps 405, 406, and 407.

At step 903, the method (900) includes identifying, by the network hub (100), the one or more NF nodes (e.g., 300A and 300B) that have been involved in the formation message based on the stored information (pre-configured information) associated with the table (e.g., Table-1), which relates to steps 405, 406, and 407. The table (e.g., Table-1) can be preconfigured or can dynamically updated based on the transmission of the message to another NF node (e.g., 300A). So, the network hub (100) determines which all NF nodes (e.g., 300A and 300B) are involved in the message formation and transmission of the message (response message).

At step 904, upon performing an action associated with step 901, the method (900) includes identifying, by the network hub (100), the one or more NF nodes (e.g., 300A and 300B) based on the header information (e.g., header field), which relates to steps 405, 406, and 407. The header field includes the list of NF nodes (e.g., 300A and 300B) that are involved and required the response for the received message.

At step 905, the method (900) includes identifying, by the network hub (100), the list associated with the one or more NF nodes (e.g., 300A and 300B) to which the response message needs to be sent, which relates to steps 405, 406, and 407.

At step 906, the method (900) includes determining whether the network hub (100) needs to send the response message to the single NF node (e.g., 300A) or the multiple NF nodes (e.g., 300A and 300B) based on at least one of the pre-configured information and the header information, which relates to steps 405, 406, and 407.

At step 907, the method (900) includes sending, by the network hub (100), the response message to the single NF node (e.g., 300A) based on a result of the determination, wherein the result indicates that the response message needs to send the single NF node (e.g., 300A), which relates to steps 406, and 407.

At step 908, the method (900) includes sending, by the network hub (100), the response message to the multiple NF nodes (e.g., 300A and 300B) based on the result of the determination, wherein the result indicates that the response message needs to send the multiple NF nodes (e.g., 300A and 300B), which relates to steps 406, and 407.

FIG. 10 is a flow diagram illustrating a method (1000) for adding information associated with the single NF node (e.g., 300A) or the multiple NF nodes (e.g., 300A and 300B) from the one or more NF nodes at the UE (200) for the data transmission in the service-based architecture, according to an embodiment as disclosed herein.

At step 1001, the method (1000) includes receiving, by the UE (200), the message from the plurality of NF nodes (e.g., 300A and 300B) via the network hub (100), which relates to step 403.

At step 1002, the method (1000) includes processing, by the UE (200), the received message, which relates to step 404.

At step 1003, the method (1000) includes preparing, by the UE (200), the response message for the plurality of NF nodes (e.g., 300A and 300B) based on processing, which relates to step 404.

At step 1004, the method (1000) includes determining, by the UE (200), whether to add information associated with the multiple NF nodes (e.g., 300A and 300B) or the single NF node (e.g., 300A) in the NF header based on one of the following condition(s), which relates to step 404.
a. Based on the received network indication: when the multiple NF nodes (e.g., 300A and 300B) sends any message to the UE (200) via the network hub (100), the network hub (100) may indicate to the UE (200) that all NFs (e.g., 300A and 300B) are expecting the response message. This is the case when the multiple NF nodes (e.g., 300A and 300B) synchronize and share a final message (i.e., received message) with the UE (200). The same header structure can be added by the network hub (100) or any other NF node (e.g., 300A and 300B) before sending the message to the UE (200).
b. Based on at least one action on network layer(s) or network module(s): every network message can have an effect on several network modules. Based on this, the UE (200) may identify which NF nodes (e.g., 300A and 300B) may be involved and accordingly send the message to the multiple NF nodes (e.g., 300A and 300B).
c. Based on the pre-configured information: in this case both the UE (200) and the network hub (100) may be aware that if the message (e.g., message-X) is received, the message must be transmitted to which NF node(s) (e.g., 300A and 300B). Because the network hub (100) cannot interpret the message, the UE (200) must include proper NF node information in the NF header, as illustrated above. If the network hub (100) understands, the network hub (100) can select which NF node to send the message based on the type of message.

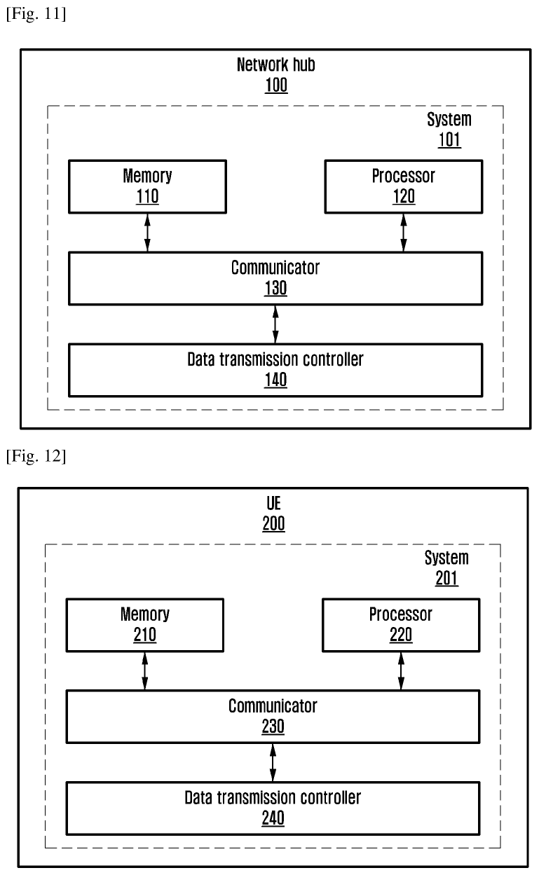

FIG. 11 illustrates a block diagram of the network hub (100) for the data transmission in the service-based architecture, according to an embodiment as disclosed herein.

In an embodiment, the network hub (100) comprises a system (101). The system (101) may include a memory (110), a processor (120), a communicator (130), and a data transmission controller (140).

In an embodiment, the memory (110) stores instructions to be executed by the processor (120) for data transmission in the service-based architecture, as discussed throughout the disclosure. The memory (110) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (110) may, in some examples, be considered a non-transitory storage medium. The term “non-transitory” may indicate that the storage medium is not embodied in a carrier wave or a propagated signal. However, the term “non-transitory” should not be interpreted that the memory (110) is non-movable. In some examples, the memory (110) can be configured to store larger amounts of information than the memory. In certain examples, a non-transitory storage medium may store data that can, over time, change (e.g., in Random Access Memory (RAM) or cache). The memory (110) can be an internal storage unit, or it can be an external storage unit of the network hub (100), a cloud storage, or any other type of external storage.

The processor (120) communicates with the memory (110), the communicator (130), the display (140), and the data transmission controller (140). The processor (120) is configured to execute instructions stored in the memory (110) and to perform various processes for data transmission in the service-based architecture, as discussed throughout the disclosure. The processor (120) may include one or a plurality of processors, maybe a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

The communicator (130) is configured for communicating internally between internal hardware components and with external devices (e.g., UE (200), a plurality of NF nodes (300A-300N), etc.) via one or more networks (e.g., Radio technology). The communicator (130) includes an electronic circuit specific to a standard that enables wired or wireless communication.

The data transmission controller (140) is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

In one embodiment, the data transmission controller (140) receives the message from the plurality of NF nodes (300A-300N). The data transmission controller (140) then sends the received message to the UE (200), wherein the received message is processed by the UE (200). The data transmission controller (140) then receives the response message from the UE (200) in response to processing the received message.

In one embodiment, the data transmission controller (140) identifies the NF node information in the received response message. The NF node information is identified based on the at least one of the preconfigured information, the header structure information of the control plane data packet, and the header format information of the NF header field. The preconfigured information comprises the type of message, the indication of the single NF node or the multiple NF nodes, and the type of NF node.

In one embodiment, the data transmission controller (140) receives the preconfigured information from the at least one network device. The data transmission controller (140) then stores the preconfigured information in the tabular format. The data transmission controller (140) then dynamically updates the preconfigured information based on the number of NF nodes of the plurality of NF nodes (300A-300N) involved during the data transmission.

In one embodiment, the data transmission controller (140) transmits the received response message to the single NF node when the identified NF node information indicates that the received response message is associated with the single NF node or transmits the received response message to the multiple NF nodes when the identified NF node information indicates that the received response message is associated with the multiple NF nodes.

In one embodiment, the data transmission controller (140) controls the plurality of NF nodes (300A-300N), wherein the data transmission controller (140) operates as the single anchor point for all UE messages.

In one embodiment, the data transmission controller (140) uses the service-based interface (SBI) to communicate with the plurality of NF nodes (300A-300N), the plurality of NF nodes (300A-300N) controls one or more services, and the one or more services comprises the connection management, the session management, the handover, and the service request.

Although FIG. 11 shows various hardware components of the network hub (100), but it is to be understood that other embodiments are not limited thereon. In other embodiments, the network hub (100) may include less or more number of components. Further, the labels or names of the components are used only for illustrative purposes and do not limit the scope of the invention. One or more components can be combined to perform the same or substantially similar functions for data transmission in the service-based architecture.

FIG. 12 illustrates a block diagram of the UE (200) for the data transmission in the service-based architecture, according to an embodiment as disclosed herein. Examples of the UE (200) include, but are not limited to a smartphone, a tablet computer, a Personal Digital Assistance (PDA), an Internet of Things (IoT) device, a wearable device, etc.

In an embodiment, the UE (200) comprises a system (201). The system (201) may include a memory (210), a processor (220), a communicator (230), and a data transmission controller (240).

In an embodiment, the memory (210) stores instructions to be executed by the processor (220) for data transmission in the service-based architecture, as discussed throughout the disclosure. The memory (210) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (210) may, in some examples, be considered a non-transitory storage medium. The term “non-transitory” may indicate that the storage medium is not embodied in a carrier wave or a propagated signal. However, the term “non-transitory” should not be interpreted that the memory (210) is non-movable. In some examples, the memory (210) can be configured to store larger amounts of information than the memory. In certain examples, a non-transitory storage medium may store data that can, over time, change (e.g., in Random Access Memory (RAM) or cache). The memory (210) can be an internal storage unit, or it can be an external storage unit of the UE (200), a cloud storage, or any other type of external storage.

The processor (220) communicates with the memory (210), the communicator (230), the display (240), and the data transmission controller (240). The processor (220) is configured to execute instructions stored in the memory (210) and to perform various processes for data transmission in the service-based architecture, as discussed throughout the disclosure. The processor (220) may include one or a plurality of processors, maybe a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

The communicator (230) is configured for communicating internally between internal hardware components and with external devices (e.g., network hub (100), a plurality of NF nodes (300A-300N), etc.) via one or more networks (e.g., Radio technology). The communicator (230) includes an electronic circuit specific to a standard that enables wired or wireless communication.

The data transmission controller (240) is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

In one embodiment, the data transmission controller (240) receives the message from the plurality of NF nodes (300A-300N) via the network hub (100). The data transmission controller (240) then processes the received message by performing one or more operations which are mentioned below.
a. The data transmission controller (240) detects the least one of the network indication, the action on network layers or the network modules, and the preconfigured information.
b. The data transmission controller (240) adds, based on the at least one of the detected network indication, the detected action on layers or modules, and the detected preconfigured information, the single NF header, or the multiple headers in the response message.
c. The data transmission controller (240) sends the response message to the network hub (100).

In one embodiment, the data transmission controller (240) adds the NF header field in any of the existing network layers, or the new network layer based on the preconfigured information shared by the at least one network device.

In one embodiment, the data transmission controller (240) provides the one or more configurations to add the NF header field to any existing network layer or new network layer, which are mentioned below.
a. The data transmission controller (240) or the at least one network device adds the NF header field after processing of layer-2 of the existing network layer, after the layer-2 header, and before the control plane data packet, wherein the layer-2 comprises the PDCP layer, the RLC layer, and the MAC layer.
b. The data transmission controller (240) or the at least one network device adds the NF header field after processing of layer-2 of the existing network layer and at end of each control plane data packet.
c. The data transmission controller (240) or the at least one network device adds the NF header field at beginning of each control plane data packet.
d. The data transmission controller (240) or the at least one network device adds the NF header field before the MAC-I packet.

In one embodiment, the data transmission controller (240) provides the one or more structuring configurations of the NF header field, which are mentioned below.
a. One-bit length for the multiple NF bit indication, three-bit length for the NF identity (NF-ID) of the specific NF node of the plurality of NF nodes (300A-300N), one-bit length for an extension bit, and one or more one-bit lengths of reserved bits.
b. One or more NF bits, wherein each bit corresponds to the specific NF node of the plurality of NF nodes (300A-300N).
c. One or more internet protocol (IP) addresses, wherein each IP address corresponds to the specific NF node of the plurality of NF nodes (300A-300N).
d. One or more port identities (IDs), wherein each port id corresponds to the specific NF node of the plurality of NF nodes (300A-300N).

Although FIG. 12 shows various hardware components of the UE (200), but it is to be understood that other embodiments are not limited thereon. In other embodiments, the UE (200) may include less or more number of components. Further, the labels or names of the components are used only for illustrative purposes and do not limit the scope of the invention. One or more components can be combined to perform the same or substantially similar functions for data transmission in the service-based architecture.

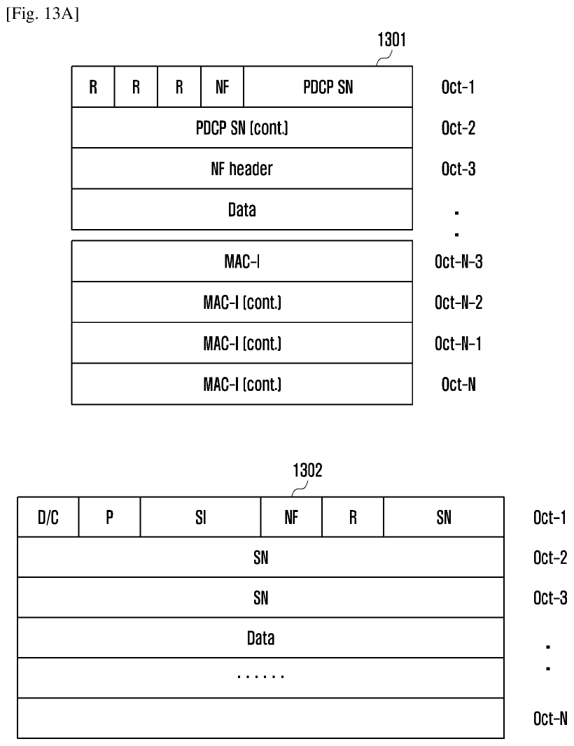

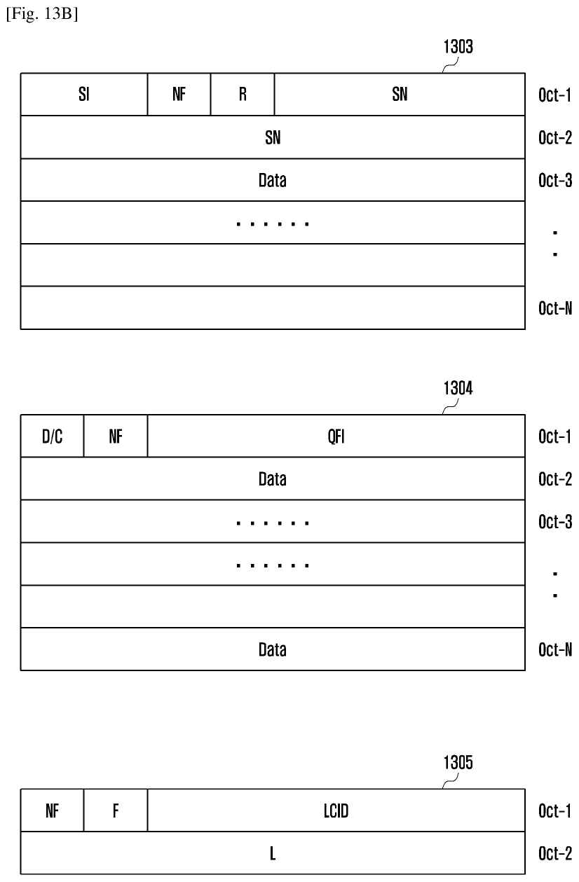

FIGS. 13A-13B illustrates an impact on the existing header structure in case a new NF header structure is added in one or more messages for the data transmission in the service-based architecture, according to an embodiment as disclosed herein.

Options (1301, 1302, 1303, 1304, and 1305) below have been presented with particular examples, however, the options may be applied to any sort of NF header option as stated above and can be applied to any network layer.

The option-1 (1301) illustrates an impact on PDCP when the NF header is added for the format of the PDCP data PDU with 12 bits PDCP SN. Format of the option-1 (1301) is applicable for SRBs that carry control plane data.

Here, an NF field represents whether the NF header field is present or not. The bit is set as “1” which means that this packet has the NF header field and if the bit is set as “0”, then this packet does not have the NF header field. The placement of the NF header can be at different places as mentioned in this invention. The length of the NF field is 1 bit. PDCP SN specifies the SN used for the PDCP control PDU, length is variable. A data field includes one of: an uncompressed PDCP Service Data Unit (SDU) (user plane data, or control plane data) and a compressed PDCP SDU (user plane data only). A MAC-I field carries a message authentication code. For the SRBs, the MAC-I field is always present. If integrity protection is not configured, the MAC-I field is still present but should be padded with padding bits set to 0.

The option-2 (1302) illustrates an impact on the RLC when the NF header is added for the AMD PDU consisting of a data field and the AMD PDU header. The AMD PDU header only contains a Segment Information (SI), a Data PDU/Control PDU (D/C), a Private (P), and NF fields. The NF field represents whether the NF header field is present or not. The bit is set as “1” which means that this packet has the NF header and if the bit is set as “0”, then this packet does not have the NF header. The placement of the NF header can be at different places as mentioned in the disclosed method and the length of the NF field is 1 bit.

The option-3 (1303) illustrates an impact on RLC when the NF header is added for the UMD PDU consisting of the Data field and the UMD PDU header. The UMD PDU header only contains the SI and NF fields. The NF field represents whether the NF header field is present or not. The bit is set as “1” which means that this packet has the NF header and if the bit is set as “0”, then the packet does not have the NF header. The placement of the NF header can be at different places as mentioned in the disclosed method, the length of the NF field is 1 bit. The SI field indicates whether the RLC PDU contains a complete RLC SDU or a first, middle, and last segment of an RLC SDU, the length of the SI field is 2-bit.

The option-4 (1304) illustrates an impact on the SDAP when the NF header is added for an SDAP data PDU. The SDAP Data PDU header only contains a QoS Flow Identifier (QFI) field and the NF field. The NF field represents whether the NF header field is present or not. The bit is set as “1” which means that this packet has an NF header and if the bit is set as “0”, then the packet does not have the NF header. The placement of the NF header can be at different places as mentioned in the disclosed method and the length of this field is 1 bit.

The option-5 (1304) illustrates the impact on MAC data PDU when the NF is added to the MAC sub header consisting of four header fields NF/F/LCID/L, where NF is network function address or ID, F stands for ‘Format’. It indicates the size of the Length field, LCID field indicates Logical Channel ID. There is one LCID field per MAC sub header. The LCID field size is 6 bits. The L indicates length of the corresponding MAC SDU or variable-sized MAC CE in bytes. A MAC sub header for fixed sized ‘MAC Control Element (MAC CE), padding, and a MAC SDU containing an Uplink (UL) Common Control Channel (CCCH) CCCH of two header fields NF/LCID. The NF field represents whether the NF header field is present or not. The bit is set as “1” which means that the packet has the NF header and if the bit is set as “0”, then the packet does not have the NF header. The placement of the NF header can be at different places as mentioned in the disclosed method. The length of this field is 1 bit. L is the length field and LCID is the logical channel ID. All these impacts are applicable to all NF header structures as described in the disclosed method. These impacts are applicable at the UE (200) as well as any NW node which can be the network hub (100), the DU, or the NF node.

In one or more embodiments, the disclosed method has several advantages, some of which are listed below.
a. Any network node communicating with another network node at the RAN or core network function, the disclosed method may also allow the UE (200) to exchange control signalling with the network through a single anchor (e.g., network hub (100)).
b. Disclosed data transmission mechanism may assist in achieving the benefits of the SBI as the disclosed data transmission mechanism facilitate the simultaneous transmission of messages to multiple nodes (e.g., NF-1 node (300A), NF-2 node (300B)). As a result, control plane latency and the number of hopes decrease.
c. The network hub (100) directly interacts with any NF node (e.g., NF-1 node (300A), NF-2 node (300B)) which can decrease overall network latency.

The various actions, acts, blocks, steps, or the like in the flow diagrams/sequence diagrams may be performed in the order presented, in a different order, or simultaneously. Further, in some embodiments, some of the actions, acts, blocks, steps, or the like may be omitted, added, modified, skipped, or the like without departing from the scope of the invention.

Unless otherwise defined, all technical and scientific terms used herein have the same meaning as commonly understood by one ordinary skilled in the art to which this invention belongs. The system, methods, and examples provided herein are illustrative only and not intended to be limiting.

While specific language has been used to describe the present subject matter, any limitations arising on account thereto, are not intended. As would be apparent to a person in the art, various working modifications may be made to the method to implement the inventive concept as taught herein. The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment.

The embodiments disclosed herein can be implemented using at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method performed by a network hub in a wireless communication system, the method comprising:
transmitting, to a terminal, a message;
receiving, from the terminal, a response message including network function (NF) information;
determining whether the response message is for a single NF entity or multiple NF entities among at least one NF entity, based on the NF information; and
transmitting, to the single NF entity or the multiple NF entities, the received response message, based on the determination.

2. The method of claim 1,
wherein the NF information is identified based on at least one of preconfigured information, header structure information of a control plane data packet, and header format information of an NF header field, wherein the preconfigured information includes a type of message, an indication of the single NF entity or the multiple NF entities, and a type of NF entity,
wherein the header structure information of the control plane data packet includes configuration information for adding a NF header field to a network layer,
wherein the configuration information for adding the NF header includes including at least one of first information associated with adding the NF header field after processing of layer-2 of the existing network layer, after a layer-2 header, and before a control plane data packet, wherein the layer-2 includes a packet data convergence protocol (PDCP) layer, a radio link control (RLC) layer, and a medium access control (MAC) layer, second information associated with adding the NF header field after processing of layer-2 of the existing network layer and at end of each control plane data packet, the third information associated with adding the NF header field at beginning of each control plane data packet, or fourth information associated with adding the NF header field before a message authentication code-integrity (MAC-I) packet,
wherein the header format information for the NF header field includes structuring configuration information of the NF header field, wherein the structuring configuration information includes at least one of first bit information associated with a one-bit length for a multiple NF bit indication, three-bit length for an NF identity (NF-ID) of a specific NF entity of the at least one NF entity one-bit length for an extension bit, and one or more one-bit lengths of reserved bits, second bit information associated with one or more NF bits, wherein each bit corresponds to the specific NF entity of the at least one NF entity, third bit information associated with one or more internet protocol (IP) addresses, wherein each IP address corresponds to the specific NF entity of the at least one NF entity, and fourth bit information associated with one or more port identities (IDs), wherein each port id corresponds to the specific NF entity of the at least one of NF entity, and
wherein the header format information is preconfigured.

3. The method of claim 1, the method further comprising:
receiving, from the at least one NF entity, the preconfigured information;
storing the preconfigured information in a tabular format;
dynamically updating the preconfigured information based on a number of NF entities involved during the data transmission; and
adding a NF header field in any of existing network layers, or a new network layer based on the preconfigured information.

4. The method of claim 1, the method further comprising
controlling the at least one NF entity, wherein the network hub operates as a single anchor point for all terminal messages,
wherein the network hub is located at a specific network function entity of the at least one NF entity, or in conjunction with a Distributed Unit (DU), or one or more NF entities for the at least one NF entity, or an independent device in a service-based architecture,
wherein a control message transmission is managed through a single layer,
wherein the network hub uses a service-based interface (SBI) to communicate with the at least one NF entity, and
wherein the at least one NF entity controls one or more services and the one or more services includes a connection management, a session management, a handover, and a service request.

5. A method performed by a terminal in a wireless communication system, the method comprising:
receiving, from a network hub, a message; and
transmitting, to the network hub, a response message including network function (NF) information based on the received message;
wherein whether the message is for a single NF entity or multiple NF entities among at least one NF entity is based on the NF information; and
wherein the received message is transmitted, via the network hub, to the single NF entity or the multiple NF entities.

6. The method of claim 5,
wherein the NF information is identified based on at least one of preconfigured information, header structure information of a control plane data packet, and header format information of an NF header field,
wherein the preconfigured information includes a type of message, an indication of the single NF entity or the multiple NF entities, and a type of NF entity,
wherein the header structure information of the control plane data packet includes configuration information for adding a NF header field to a network layer,
wherein the configuration information for adding the NF header includes including at least one of first information associated with adding the NF header field after processing of layer-2 of the existing network layer, after a layer-2 header, and before a control plane data packet, wherein the layer-2 includes a packet data convergence protocol (PDCP) layer, a radio link control (RLC) layer, and a medium access control (MAC) layer, second information associated with adding the NF header field after processing of layer-2 of the existing network layer and at end of each control plane data packet, the third information associated with adding the NF header field at beginning of each control plane data packet, or fourth information associated with adding the NF header field before a message authentication code-integrity (MAC-I) packet,
wherein the header format information for the NF header field includes structuring configuration information of the NF header field, wherein the structuring configuration information includes at least one of first bit information associated with a one-bit length for a multiple NF bit indication, three-bit length for an NF identity (NF-ID) of a specific NF entity of the at least one NF entity one-bit length for an extension bit, and one or more one-bit lengths of reserved bits, second bit information associated with one or more NF bits, wherein each bit corresponds to the specific NF entity of the at least one NF entity, third bit information associated with one or more internet protocol (IP) addresses, wherein each IP address corresponds to the specific NF entity of the at least one NF entity, and fourth bit information associated with one or more port identities (IDs), wherein each port id corresponds to the specific NF entity of the at least one of NF entity, and
wherein the header format information is preconfigured.

7. The method of claim 5, the method further comprising:
detecting at least one of a network indication, an action on network layers or network modules, or preconfigured information, based on the received message; and
adding a single NF header or multiple headers in the response message, based on the determination.

8. The method of claim 5, the method further comprising
adding NF header field in any of existing network layers, or a new network layer based on preconfigured information.

9. A method performed by a network hub in a wireless communication system, the method comprising:
a transceiver; and
a controller configured to:
transmit, to a terminal, a message,
receive, from the terminal, a response message including network function (NF) information,
determine whether the response message is for a single NF entity or multiple NF entities among at least one NF entity, based on the NF information, and
transmit, to the single NF entity or the multiple NF entities, the
received response message, based on the determination.

10. The network hub of claim 9,
wherein the NF information is identified based on at least one of preconfigured information, header structure information of a control plane data packet, and header format information of an NF header field,
wherein the preconfigured information includes a type of message, an indication of the single NF entity or the multiple NF entities, and a type of NF entity,
wherein the header structure information of the control plane data packet includes configuration information for adding a NF header field to a network layer,
wherein the configuration information for adding the NF header includes including at least one of first information associated with adding the NF header field after processing of layer-2 of the existing network layer, after a layer-2 header, and before a control plane data packet, wherein the layer-2 includes a packet data convergence protocol (PDCP) layer, a radio link control (RLC) layer, and a medium access control (MAC) layer, second information associated with adding the NF header field after processing of layer-2 of the existing network layer and at end of each control plane data packet, the third information associated with adding the NF header field at beginning of each control plane data packet, or fourth information associated with adding the NF header field before a message authentication code-integrity (MAC-I) packet,
wherein the header format information for the NF header field includes structuring configuration information of the NF header field, wherein the structuring configuration information includes at least one of first bit information associated with a one-bit length for a multiple NF bit indication, three-bit length for an NF identity (NF-ID) of a specific NF entity of the at least one NF entity one-bit length for an extension bit, and one or more one-bit lengths of reserved bits, second bit information associated with one or more NF bits, wherein each bit corresponds to the specific NF entity of the at least one NF entity, third bit information associated with one or more internet protocol (IP) addresses, wherein each IP address corresponds to the specific NF entity of the at least one NF entity, and fourth bit information associated with one or more port identities (IDs), wherein each port id corresponds to the specific NF entity of the at least one of NF entity, and
wherein the header format information is preconfigured.

11. The network hub of claim 9, the controller is further configured to:
receive, from the at least one NF entity, the preconfigured information, store the preconfigured information in a tabular format,
dynamically update the preconfigured information based on a number of NF entities involved during the data transmission, and
add a NF header field in any of existing network layers, or a new network layer based on the preconfigured information.

12. The network hub of claim 9, the controller is further configured to:
control the at least one NF entity, wherein the network hub operates as a single anchor point for all terminal messages,
wherein the network hub is located at a specific network function entity of the at least one NF entity, or in conjunction with a Distributed Unit (DU), or one or more NF entities for the at least one NF entity, or an independent device in a service-based architecture,
wherein a control message transmission is managed through a single layer,
wherein the network hub uses a service-based interface (SBI) to communicate with the at least one NF entity, and
wherein the at least one NF entity controls one or more services and the one or more services includes a connection management, a session management, a handover, and a service request.

13. A terminal in a wireless communication system, the terminal comprising:
a transceiver; and
a controller configured to:
receive, from a network hub, a message, and
transmit, to the network hub, a response message including network function (NF) information based on the received message,
wherein whether the message is for a single NF entity or multiple NF entities among at least one NF entity is based on the NF information, and
wherein the received message is transmitted, via the network hub, to the single NF entity or the multiple NF entities.

14. The terminal of claim 13,
wherein the NF information is identified based on at least one of preconfigured information, header structure information of a control plane data packet, and header format information of an NF header field, wherein the preconfigured information includes a type of message, an indication of the single NF entity or the multiple NF entities, and a type of NF entity,
wherein the header structure information of the control plane data packet includes configuration information for adding a NF header field to a network layer,
wherein the configuration information for adding the NF header includes including at least one of first information associated with adding the NF header field after processing of layer-2 of the existing network layer, after a layer-2 header, and before a control plane data packet, wherein the layer-2 includes a packet data convergence protocol (PDCP) layer, a radio link control (RLC) layer, and a medium access control (MAC) layer, second information associated with adding the NF header field after processing of layer-2 of the existing network layer and at end of each control plane data packet, the third information associated with adding the NF header field at beginning of each control plane data packet, or fourth information associated with adding the NF header field before a message authentication code-integrity (MAC-I) packet,
wherein the header format information for the NF header field includes structuring configuration information of the NF header field, wherein the structuring configuration information includes at least one of first bit information associated with a one-bit length for a multiple NF bit indication, three-bit length for an NF identity (NF-ID) of a specific NF entity of the at least one NF entity one-bit length for an extension bit, and one or more one-bit lengths of reserved bits, second bit information associated with one or more NF bits, wherein each bit corresponds to the specific NF entity of the at least one NF entity, third bit information associated with one or more internet protocol (IP) addresses, wherein each IP address corresponds to the specific NF entity of the at least one NF entity, and fourth bit information associated with one or more port identities (IDs), wherein each port id corresponds to the specific NF entity of the at least one of NF entity, and
wherein the header format information is preconfigured.

15. The terminal of claim 13, the controller is further configured to:
detect at least one of a network indication, an action on network layers or network modules, or preconfigured information, based on the received message,
add a single NF header or multiple headers in the response message, based on the determination, and
add NF header field in any of existing network layers, or a new network layer based on preconfigured information.
